(19) United States
(12) Patent Application Publication
(10) Pub. No.: US 2022/0248646 A1
(43) Pub. Date: Aug. 11, 2022

(54) PROTEIN SKIMMER CAP

(71) Applicant: Ryan Adair OPENSHAW, Grande Prairie (CA)

(72) Inventor: Ryan Adair OPENSHAW, Grande Prairie (CA)

(21) Appl. No.: 17/171,614

(22) Filed: Feb. 9, 2021

(51) Int. Cl. A01K 63/04

(52) U.S. Cl. CPC A01K 63/04

(57) ABSTRACT

A protein skimmer cap is provided. A protein skimmer cap for attachment to a protein skimmer, the cap preventing outward spray of aquarium waste, comprising a surrounding member enclosing a center member and an end member. The center member is affixed to the center of the surrounding member and the end member is affixed to the center member. A method of employing the protein skimmer cap to prevent outward spray of aquarium waste from protein skimmer, comprising applying the end member of the protein skimmer cap onto a protein skimmer collection cup such that one or more air vents remain unblocked and the surrounding member encloses all of the one or more air vents.

### FIELD OF THE INVENTION

The present disclosure relates to a protein skimmer cap, more specifically but not by way of limitation, a protein skimmer cap that prevents the outward spray of aquarium waste.

### BACKGROUND

Protein skimmers are commonly employed in saltwater, brackish and freshwater aquarium systems for waste management and removal, as well as for providing water and air circulation within the aquarium. The protein skimmer primarily functions to mix air, water, dissolved organics and decayed material from the aquarium such that a foam is produced. This foam is typically formed within an isolated compartment of a protein skimmer system, commonly referred to as a protein skimmer collection cup, which may be removed and disposed of from the overall system. From time to time, the foam may overflow in the protein skimmer collection cup or through air vents in the protein skimmer collection cup lids, and spray outward. This is especially common when protein skimmers are first introduced, during different periods of the Nitrogen Cycle within the aquarium, or when any new chemicals are added to the aquarium. This spray creates additional work to clean, it can cause damage to the surround cabinets and furniture and emits a foul odor. In addition to the mess itself, the spraying of foam can be dangerous or damaging to any electrical outlets of devices within proximity to the skimmer collection cup.

JP Pub. No. 2009045001 A (Naradaira et al.) discloses a protein skimmer system equipped with a separated material recovering vessel which encases the skimmer collection cup. Shortcomings include an inability to employ the separated material recovering vessel onto various protein skimmer models and time-consuming disassembly of the separated material recovering vessel for further maintenance.

CN Pub. No. 202808655 U (Gu) discloses a skimmer collection cup lid for a protein skimmer. Shortcomings include an inability to employ the separated material recovering vessel onto various protein skimmer models and time-consuming disassembly of the skimmer collection cup lid for further maintenance.

DE Pub. No. 202016006406 U1 (Zeitler) discloses a hangable splash guard for a protein skimmer. Shortcomings include the hangable splash guard's lack of stability on the skimmer collection cup lid.

All documents cited herein are incorporated by reference.

There is a need for a protein skimmer cap that prevents the outward spray of aquarium waste from a protein skimmer collection cup onto plumbing lines, wiring, the cabinet area and other equipment while leaving any potential air vents unblocked, is simple to clean and employ on a variety of different protein skimmer models, and reduces maintenance time and effort.

### BRIEF SUMMARY

It is the object of the present invention to provide a protein skimmer cap. A protein skimmer cap for attachment to a protein skimmer, the cap preventing outward spray of aquarium waste, comprising a surrounding member enclosing a center member and an end member. The center member is affixed to the center of the surrounding member and the end member is affixed to the center member.

In accordance with an aspect of the invention, there is provided a method of employing the protein skimmer cap to prevent outward spray of aquarium waste from protein skimmer, comprising applying the end member of the protein skimmer cap onto a protein skimmer collection cup such that one or more air vents remain unblocked and the surrounding member encloses all of the one or more air vents.

In accordance with an embodiment of the invention, the surrounding member is concave shaped.

In accordance with an embodiment of the invention, the surrounding member is rectangular shaped.

In accordance with an embodiment of the invention, the surrounding member is weighted.

In accordance with an embodiment of the invention, the center member is cylindrical shaped.

In accordance with an embodiment of the invention, the center member is rectangular shaped.

In accordance with an embodiment of the invention, the center member is weighted.

In accordance with an embodiment of the invention, the center member is hollow.

In accordance with an embodiment of the invention, the center member is solid.

In accordance with an embodiment of the invention, the end member is concave shaped.

In accordance with an embodiment of the invention, the end member is cylindrical shaped.

In accordance with an embodiment of the invention, the end member is rectangular shaped.

In accordance with an embodiment of the invention, the end member is weighted.

In accordance with an embodiment of the invention, the end member is hollow.

In accordance with an embodiment of the invention, the end member is solid.

In accordance with an embodiment of the invention, the protein skimmer cap is composed of plastic.

In accordance with an embodiment of the invention, the protein skimmer cap is composed of clay.

In accordance with an embodiment of the invention, protein skimmer cap is built into a protein skimmer system.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a perspective view 100 in accordance with one embodiment.

FIG. 2 illustrates an application 200 in accordance with one embodiment.

FIG. 3 illustrates a section view before protein spray 300 in accordance with one embodiment.

FIG. 4 illustrates a section view during protein spray 400 in accordance with one embodiment.

FIG. 5 illustrates a hollow version 500 in accordance with one embodiment.

FIG. 6 illustrates a solid version 600 in accordance with one embodiment.

FIG. 7 illustrates a hollow version 700 in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

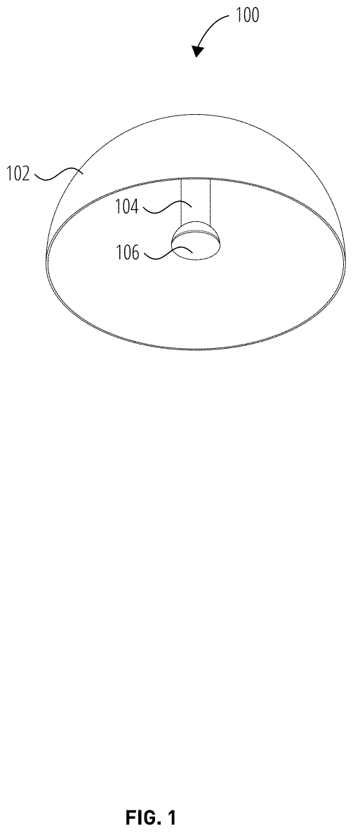

FIG. 1 depicts a perspective view 100 of a protein skimmer cap as in one embodiment. The protein skimmer cap is attached to a protein skimmer and employed to prevent the outward spray of aquarium waste comprises a surrounding member 102 enclosing a center member 104 and an end member 106, where the center member 104 is affixed to the center of the surrounding member 102 and the end member 106 is affixed to the center member 104. The protein skimmer cap may be manufactured in a variety of sizes to accommodate various protein skimmers models or can be built into a protein skimmer system. The protein skimmer cap may be composed from materials such as, but not limited to, plastic or clay.

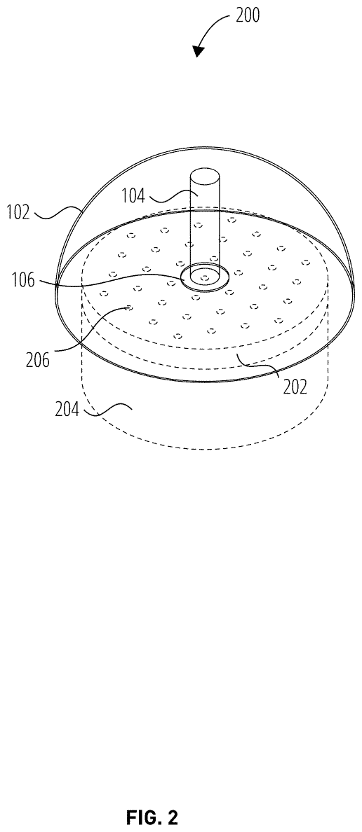

FIG. 2 depicts an application 200 of a protein skimmer cap onto a lid 202 of a protein skimmer collection cup 204, as in one embodiment. The surrounding member 102 is shown encompassing the entire lid 202 of the protein skimmer collection cup 204. Air vents 206 on the surface of the lid 202 remained unblocked, allowing gas exchange between the protein skimmer collection cup 204 and the surrounding environment. In the embodiment shown, the surrounding member 102 is a concave shaped, the center member 104 is cylindrical shaped and the end member 106 is circular shaped. In other embodiments, the surrounding member 102 may be rectangular shaped. In other embodiments, the surrounding member 102 may be weighted to ensure stability of the protein skimmer cap onto the lid 202 of the protein skimmer collection cup 204.

A method of employing the protein skimmer cap to prevent the outward spray of aquarium waste from protein skimmer comprises applying the end member 106 of the protein skimmer cap onto a protein skimmer collection cup 204 such that one or more air vents 206 remain unblocked and the surrounding member 102 encloses all of the air vents 206. During maintenance, the protein skimmer cap may be easily removed off of the protein skimmer collection cup 204 and cleaned to reduce the presence of foul odors brought on by the decaying aquarium waste.

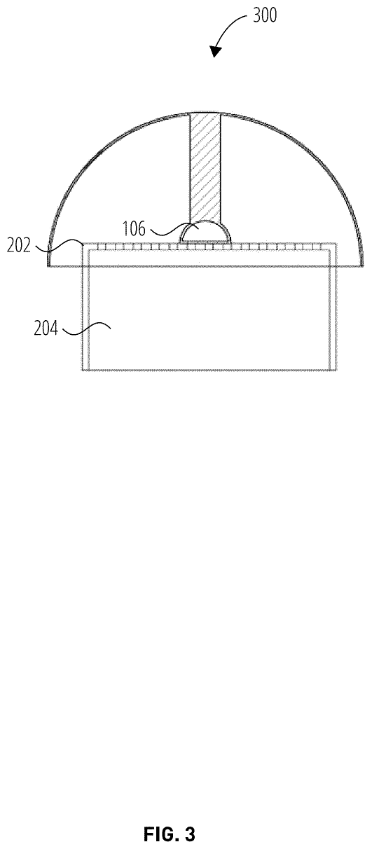

FIG. 3 depicts a section view before protein spray 300 of a protein skimmer cap placed onto a lid 202 of a protein skimmer collection cup 204 similar to FIG. 2, as in one embodiment. This embodiment also displays an end member 106 with a concave shape.

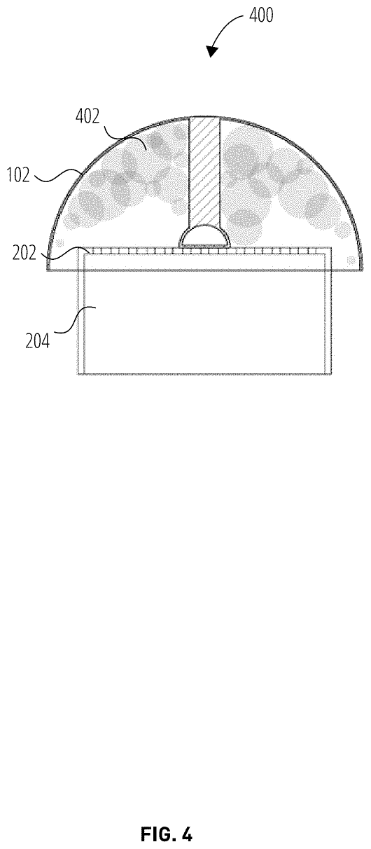

FIG. 4 depicts a section view during protein spray 400 of a protein skimmer cap placed onto a lid 202 of a protein skimmer collection cup 204, as in one embodiment. The aquarium waste 402, which is initially ejected from one or more air vents 206, is prevented from spraying outwards as the surrounding member 102 encompasses the entirety of the lid 202 of the protein skimmer collection cup 204. The containment of the spray by the protein skimmer cap shelters nearby accessories such as plumbing lines, wiring, the cabinet area and other equipment from damage, resulting in reduced maintenance time and effort.

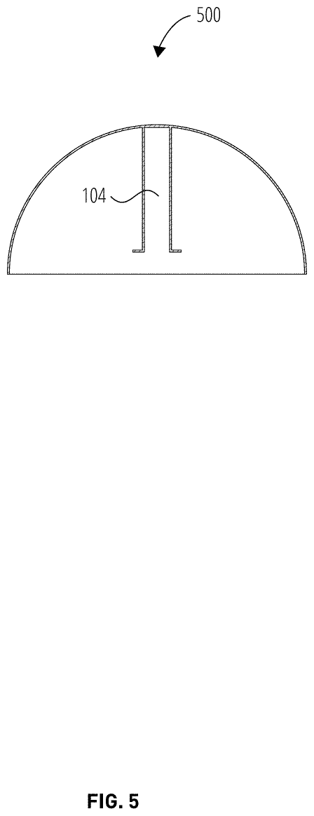

FIG. 5 depicts a hollow version 500 of a center member 104 of a protein skimmer cap as in one embodiment. This embodiment also displays a solid end member 106 with a rectangular shape. In other embodiments, the center member 104 may be weighted to ensure stability of the protein skimmer cap onto the lid 202 of the protein skimmer collection cup 204.

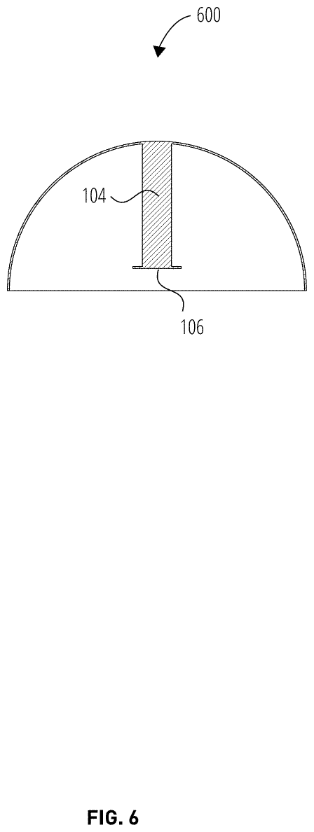

FIG. 6 depicts a solid version 600 of a center member 104 of a protein skimmer cap as in one embodiment. In other embodiments, the center member 104 may be rectangular shaped.

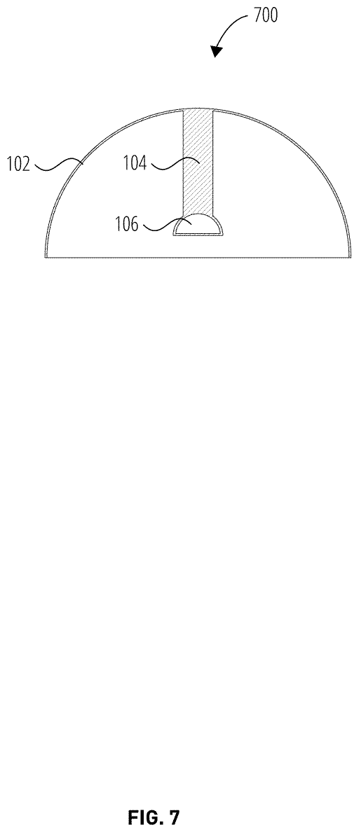

FIG. 7 depicts a hollow version 700 of an end member 106 of a protein skimmer cap as in one embodiment. In other embodiments, the end member 106 may be weighted to ensure stability of the protein skimmer cap onto the lid 202 of the protein skimmer collection cup 204.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

What is claimed is:

1. A protein skimmer cap for attachment to a protein skimmer, said cap preventing outward spray of aquarium waste, comprising:
a surrounding member enclosing a center member and an end member;
said center member is affixed to the center of said surrounding member;
said end member is affixed to said center member.

2. The protein skimmer cap of claim 1, wherein said surrounding member is concave shaped.

3. The protein skimmer cap of claim 1, wherein said surrounding member is rectangular shaped.

4. The protein skimmer cap of claim 1, wherein said surrounding member is weighted.

5. The protein skimmer cap of claim 1, wherein said center member is cylindrical shaped.

6. The protein skimmer cap of claim 1, wherein said center member is rectangular shaped.

7. The protein skimmer cap of claim 1, wherein said center member is weighted.

8. The protein skimmer cap of claim 1, wherein said center member is hollow.

9. The protein skimmer cap of claim 1, wherein said center member is solid.

10. The protein skimmer cap of claim 1, wherein said end member is concave shaped.

11. The protein skimmer cap of claim 1, wherein said end member is rectangular shaped.

12. The protein skimmer cap of claim 1, wherein said end member is circular shaped.

13. The protein skimmer cap of claim 1, wherein said end member is weighted.

14. The protein skimmer cap of claim 1, wherein said end member is hollow.

15. The protein skimmer cap of claim 1, wherein said end member is solid.

16. The protein skimmer cap of claim 1, wherein said protein skimmer cap is composed of plastic.

17. The protein skimmer cap of claim 1, wherein said protein skimmer cap is composed of clay.

18. The protein skimmer cap of claim 1, wherein said protein skimmer cap is built into a protein skimmer system.

19. A method of employing said protein skimmer cap from claim 1, to prevent outward spray of aquarium waste from protein skimmer, comprising:
applying said end member of said protein skimmer cap onto a protein skimmer collection cup such that one or more air vents remain unblocked and said surrounding member encloses all of said one or more air vents.
